(19) United States
(12) Patent Application Publication
(10) Pub. No.: US 2023/0017883 A1
(43) Pub. Date: Jan. 19, 2023

(54) Baby Bottle Pager

(71) Applicants: Dadron McCall, Bennettsville, SC (US); Jamail N. Oneil, Clio, SC (US)

(72) Inventors: Dadron McCall, Bennettsville, SC (US); Jamail N. Oneil, Clio, SC (US)

(21) Appl. No.: 17/855,854

(22) Filed: Jul. 1, 2022

Related U.S. Application Data
(60) Provisional application No. 63/223,096, filed on Jul. 19, 2021.

(51) Int. Cl. A61J 9/00; G08B 7/06; G08B 25/10; H04W 4/029; H04W 4/80

(52) U.S. Cl. CPC A61J 9/00; G08B 7/06; G08B 25/10; H04W 4/029; H04W 4/80; A61J 2200/70; A61J 2205/60

(57) ABSTRACT

A locating system for finding a lost or misplaced baby bottle, sippy cup, or other children's drinkware. The locating system comprises a sleeve component configured to partially encapsulate the baby bottle or sippy cup. An alerting component is positional and securable within an external pouch in the sleeve component. The alerting component comprises a location indicator configured to emit a signal indicating a location of the baby bottle or sippy cup. The signal may be audible, visual, or vibratory. The alerting component is wirelessly activatable by a remote controller configured to select the desired signal and a volume of the signal.

### CROSS-REFERENCE TO RELATED APPLICATION

The present application claims priority to, and the benefit of, U.S. Provisional Application No. 63/223,096, which was filed on Jul. 19, 2021 and is incorporated herein by reference in its entirety.

### FIELD OF THE INVENTION

The present invention generally relates to a system for finding infant and child drinkware, and more specifically to an alerting system for easily locating a lost or misplaced baby bottle or sippy cup. Accordingly, the present specification makes specific reference thereto. However, it is to be appreciated that aspects of the present invention are also equally amenable to other like applications, devices and methods of manufacture.

### BACKGROUND

Parents, guardians, and caregivers of small children understand all too well the struggle of losing track of baby bottles and sippy cups. Children often accidentally drop or deliberately throw around their bottles and cups when interacting with their environment. Because the bottles and cups are rounded, they often roll off and become lost. Children become very upset and throw tantrums as well when they cannot find their drinks, which can be overwhelming and frustrating for their caregivers. A lot of time and energy is wasted each day looking for lost bottles and sippy cups, especially in daycares. When they cannot be located, they must be replaced, which can be very expensive.

A baby bottle is a feeding bottle having an attached teat or nipple on the top opening that an infant or child can suck on and thereby drank from directly. A sippy cup or training cup is a drinking cup specifically designed for toddlers which prevents or reduces spills. Sippy cups, as opposed to traditional open cups, have a top which designed to prevent spills, and the child drinks either through a spout or straw. Baby bottles and sippy cups are typically constructed from a solid non-breakable material, such as plastic.

There are existing electronic object locators to help locate lost or misplaced objects. Commonly employed systems include radiofrequency identification (RFID) tracking technology, Wi-Fi, and global positioning system tracking chips. Applications for these systems include locating lost phones, lost pets, supply chain tracking, etc. These systems tend to be relatively expensive and overly sophisticated for simply finding a relatively nonessential and less expensive item such as a baby bottle or sippy cup. Additionally, existing systems have no way to easily attach to the bottle or sippy cup.

Therefore, there exists a long felt need in the art for an improved locating system designed for finding a misplaced baby bottle or sippy cup. More specifically, there is a long felt need in the art for a device configured to alert a parent or caregiver of the location of the lost baby bottle or sippy cup. There is also long felt need in the art for an attachment for the baby bottle or sippy cup that is aesthetically pleasing to infants and children. Finally, there exists in the art a long felt need for a locating device that is easily cleanable without harming the device.

In this manner, the improved locating and alerting system of the present invention accomplishes all of the forgoing objectives, thereby providing an easy solution finding a lost baby bottle or sippy cup. A primary feature of the present invention is a decorated and colorful soft drink sleeve for baby bottles and sippy cups that is aesthetically pleasing to infants and children and allows caregivers to simply page the cup when it is lost or misplaced. Another feature of the present invention is an audio alert device that is positional in the sleeve that is activatable remotely. Finally, the improved locating and alerting system of the present invention provides a cost-effective alternative to buying new baby bottles and cups to replace ones that have disappeared.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a locating system. The locating system is configured for indicating a position of a lost or misplaced baby or child's drinkware, such as a baby bottle or a sippy cup. The locating system comprises a sleeve component, an alerting component, and a remote controller.

The sleeve component is configured to partially encapsulate a baby bottle, a child's sippy cup, or a child's drinkware. The sleeve component is flexible and stretchy in nature to facilitate a snug fit around the baby bottle, sippy cup, or child's drinkware. The sleeve component comprises an outer surface that may comprise an exterior indicia. The sleeve component further comprises an external pouch.

The external pouch is attached to or integrated into the outer surface. The external pouch is configured to retain the alerting component. The external pouch may be at least partially transparent and comprises an opening and a closure. The closure is configured to temporarily secure the alerting component in place when positioned within the external pouch. The external pouch is configured to allow the transmission of a signal emitted by the alerting component.

The alerting component is removably insertable within the external pouch. The alerting component comprises a location indicator. The location indicator is configured to emit an audible alert, a visual alert, a vibratory alert, or a combination thereof. The location indicator may comprise a speaker, a light, a vibrator, or a combination thereof. The alerting component further comprises a communication receiving element and a battery.

The remote controller is configured to activate the alerting component wirelessly and remotely. The remote controller comprises a transmitting element. The transmitting element is in wireless communication with the communication receiving element of the alerting component. The remote controller further comprises a volume controller. The volume controller is configured to control a volume of an audible signal emitted by the location indicator of the alerting component. The remote controller further comprises a message selector. The message selector is configured to select a signal to be emitted by the location indicator of the alerting component.

The locating system further comprises a charging base. The charging base is configured to charge the remote controller and the alerting component. The charging base is adapted to directly receive the remote controller for charging. The charging base is further configured to directly receive or wirelessly charge the alerting component when it is removed from the external pouch of the sleeve component.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a locating system of the present invention for indicating a position of a baby bottle, sippy cup, or other children's drinkware in accordance with the disclosed architecture.

FIG. 2 illustrates an exploded view of a sleeve component and an alerting component of the locating system of the present invention for use with a baby bottle in accordance with the disclosed architecture.

FIG. 3 illustrates a perspective view of the sleeve component of the locating system of the present invention partially encapsulating the baby bottle in accordance with the disclosed architecture.

FIG. 4 illustrates an exploded view of the sleeve component and the alerting component of the locating system of the present invention for use with a sippy cup in accordance with the disclosed architecture.

FIG. 5 illustrates a perspective view of the sleeve component of the locating system of the present invention partially encapsulating the sippy cup in accordance with the disclosed architecture.

FIG. 6 illustrates a perspective view of a pouch of the sleeve component of the locating system of the present invention in accordance with the disclosed architecture.

FIG. 7 illustrates a side view of the sleeve component of the locating system of the present invention in accordance with the disclosed architecture.

FIG. 8 illustrates a perspective view of the sleeve component of the locating system of the present invention partially encapsulating the baby bottle in accordance with the disclosed architecture.

FIG. 9 illustrates an overhead view of the alerting component of the locating system of the present invention in accordance with the disclosed architecture.

FIG. 10 illustrates a side view of the alerting component of the locating system of the present invention in accordance with the disclosed architecture.

FIG. 11 illustrates a perspective view of a remote controller of the locating system of the present invention in accordance with the disclosed architecture.

FIG. 12 illustrates a schematic view of the remote controller engaging the alerting component of the locating system of the present invention in accordance with the disclosed architecture.

FIG. 13 illustrates a schematic view of the remote controller engaging the alerting component of the locating system of the present invention to find a lost baby bottle in accordance with the disclosed architecture.

FIG. 14 illustrates a perspective view of the remote controller of the locating device of the present invention linked to a smart phone in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a locating system comprising an alerting component housed within a removable drink sleeve which a baby bottle or sippy cup can easily slide into. The sleeve is typically constructed from a soft material and may be configured in various colors and decorations. The sleeve may also display graphics, such as animal pictures or cartoon characters, to make the design kid friendly. A small pouch may be positioned in the side of the sleeve material. Enclosed in this pouch or slot with an is an audio alert device. The audio alert device may be secured within the pouch via a hook and loop attachment, or other mechanical fastening system. The audio device can be removed from the pouch to wash the cup sleeve if desired.

The locating system further comprises a remote control and charging base station. When a bottle or sippy cup is misplaced, a user simply activates the location pager on the remote control. This causes the audio alert device's alarm to go off. The remote control can increase the volume of the sound if the alarm is not initially heard. The pouch may have small holes in the side so that the sound can escape and be heard. The user then simply follows the sound to the source to find the missing baby bottle or sippy cup.

The locating system is designed to find a position of a lost or misplaced baby bottle, sippy cup, or other children's drinkware. An elastic or stretchable sleeve or band is configured to encapsulate the baby bottle or sippy cup at least partially. An alerting component is positional and securable within an external pouch in the sleeve or band. The alerting component comprises a location indicator configured to emit a signal indicating a location and position of the lost or misplaced baby bottle or sippy cup. The emitted signal may be audible, visual, vibratory, or a combination thereof. The alerting component is wirelessly activatable by a remote controller configured to select the desired signal and a volume of the signal.

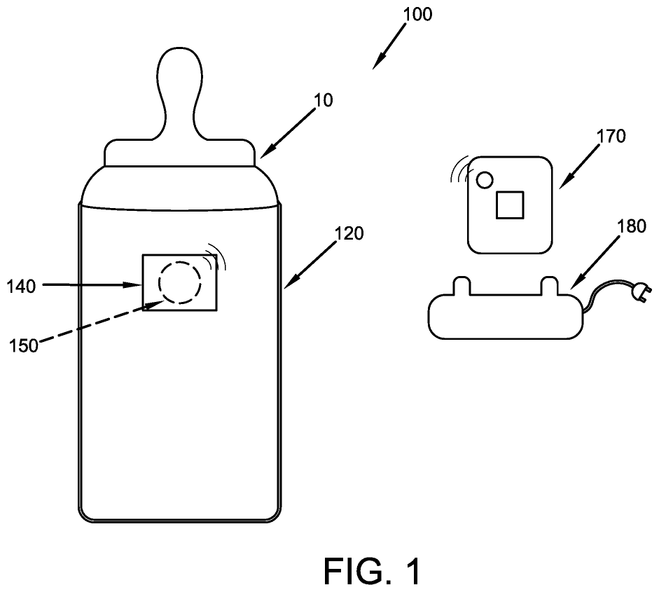

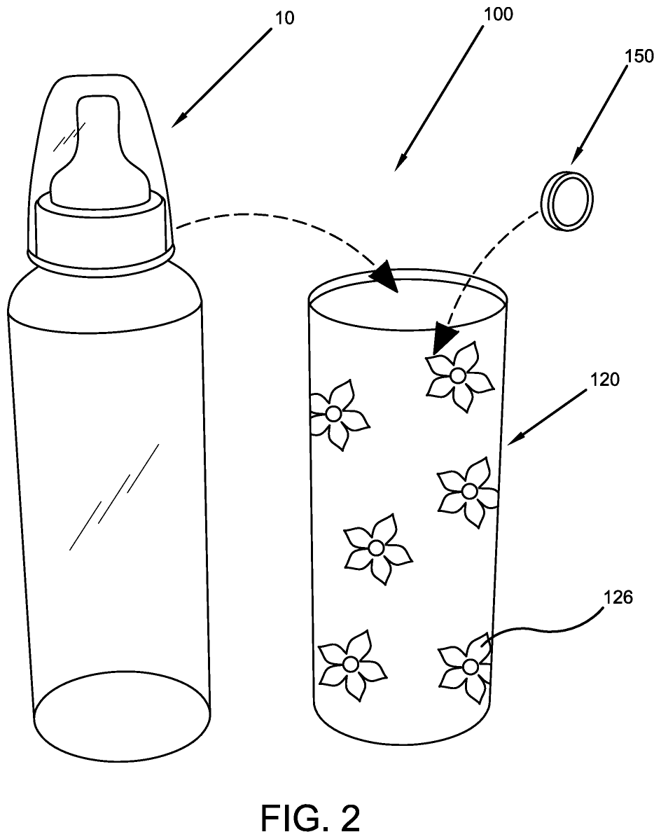

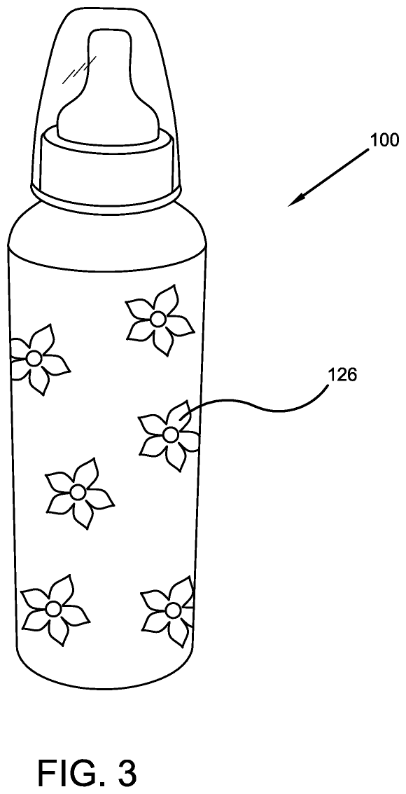

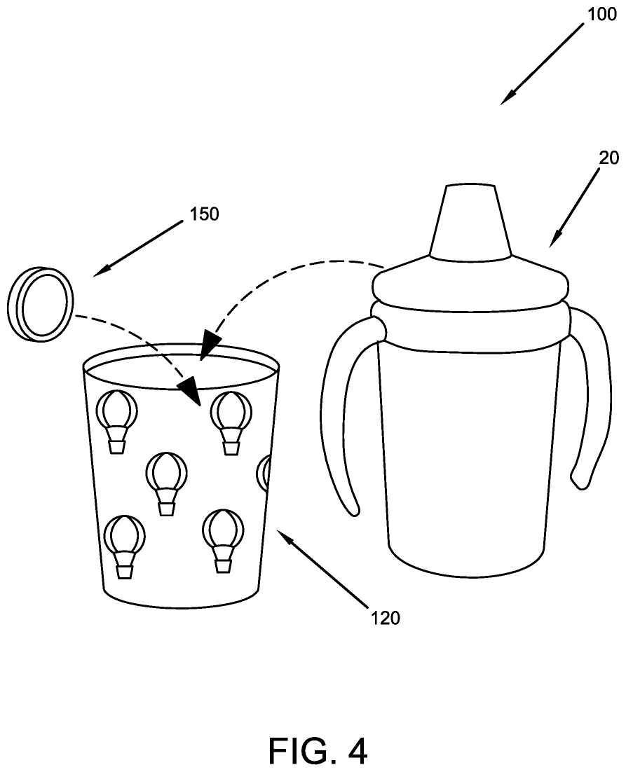

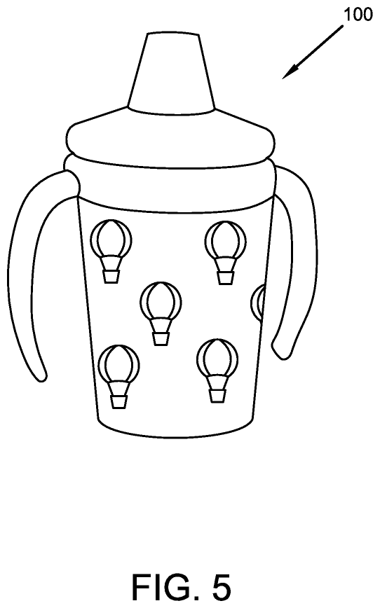

Referring initially to the drawings, FIGS. 1-14 illustrate a locating system 100. The locating system 100 is configured to indicate and broadcast a current position of a baby or child's drinkware. The child's drinkware may be a baby bottle 10 as illustrated in FIGS. 2 and 3, a sippy cup 20 as illustrated in FIGS. 4 and 5, or any other similar cylindrical drinkware used by infants and children that may be easily lost or misplaced. The locating system 100 is reusable and may be used on many different bottles and cups.

As illustrated in FIG. 1, the locating system 100 comprises a sleeve component 120, an alerting component 150, and a remote controller 170. The sleeve component 120 is configured to partially encapsulate the baby bottle 10, the child's sippy cup 20, or other drinkware. The sleeve component 120 is generally flexible and stretchy in nature to facilitate a snug fit around the baby bottle 10, sippy cup 20, or child's drinkware. The sleeve component 120 may be constructed from an elastic material, such as a polymer or polyurethane rubber, synthetics, or natural materials with elastic properties. To encapsulate the drinkware, the sleeve component 120 is stretched over the drinkware and allowed to contract back for a tight fit. The sleeve component 120 may also act as an insulator.

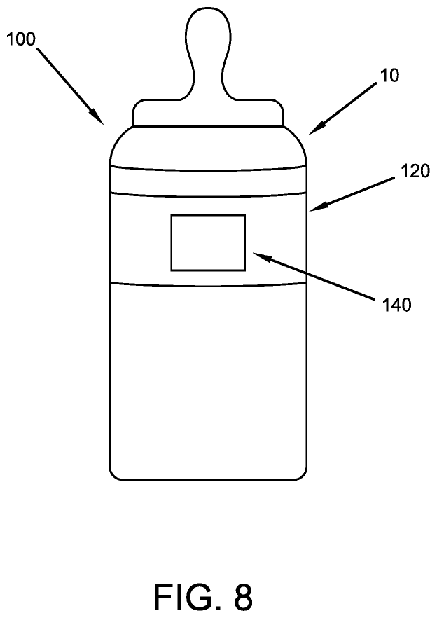

The sleeve component 120 is typically constructed as a hollow tube or cylinder and comprises an inner surface 122 and an outer surface 124. The inner surface 122 engages the encapsulated drinkware. Alternatively, the sleeve component 120 may be conducted as a band as illustrated in FIG. 8. The outer surface 124 may comprise at least one exterior indicia 126. The at least one exterior indicia 126 may be a color, combination of colors, a pattern, a graphic, a logo, a cartoon, a picture, or the like, or any combination thereof. For example, the at least one exterior indicia 126 may be a design pleasing to an infant or young child as illustrated in FIGS. 2 and 3.

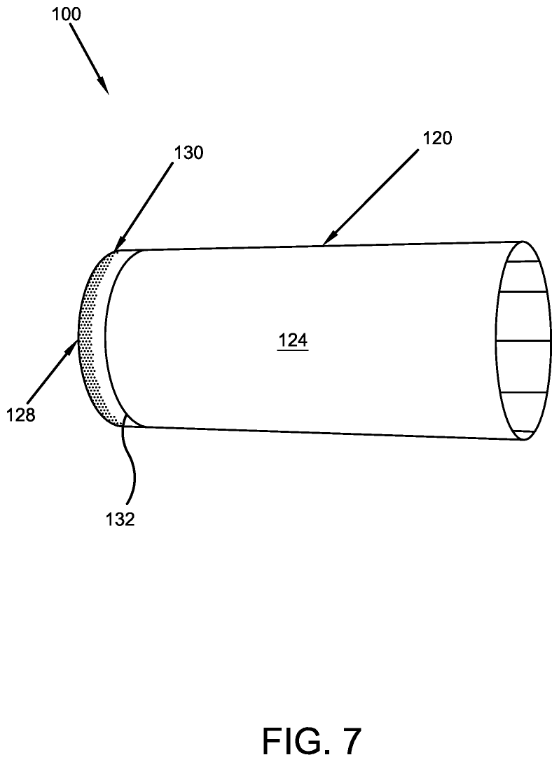

Alternatively, as illustrated in FIG. 7, the sleeve component 120 may further comprise a bottom 128. The bottom 128 is configured to fit around a bottom of the drinkware. The bottom 128 may comprise a textured or non-slip surface 130. The textured or non-slip surface 130 may help keep the encapsulated drinkware from spilling. The bottom 128 may also comprise a weighted element 132. The weighted element 132 may be a weighted ring or plate in the bottom 128 to provide additional stability for the encapsulated drinkware.

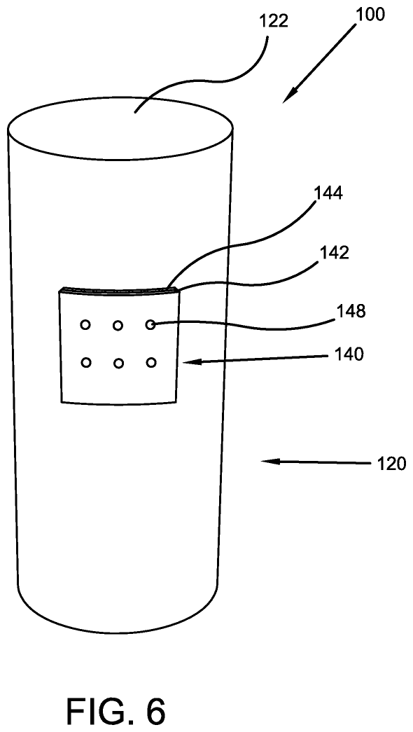

As illustrated in FIG. 6, the sleeve component 120 further comprises an external pouch 140. The external pouch 140 is constructed of a similar material as the sleeve component 120 and is attached, adhered, or otherwise integrated into the outer surface 124. The external pouch 140 is configured to retain the alerting component 150. The external pouch 140 may be solid or at least partially transparent. The external pouch 140 comprises an opening 142 or slit and a closure 144. The closure 144 is configured to temporarily secure the alerting component 150 in place when positioned within the external pouch 140. The closure 144 may be a hook and loop fastener or any other mechanical closure system.

The external pouch 140 is configured to allow the transmission of a signal emitted by the alerting component 150. A plurality of small apertures or openings 148 may be integrated into the external pouch 140. A plurality of small apertures or openings 148 are configured to allow sound and light from the alerting component 150 to penetrate the external pouch 140. The external pouch 140 may further comprise a water-resistant interior.

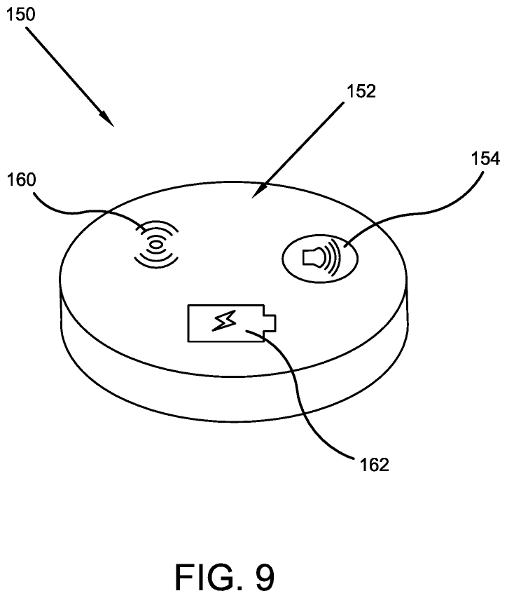

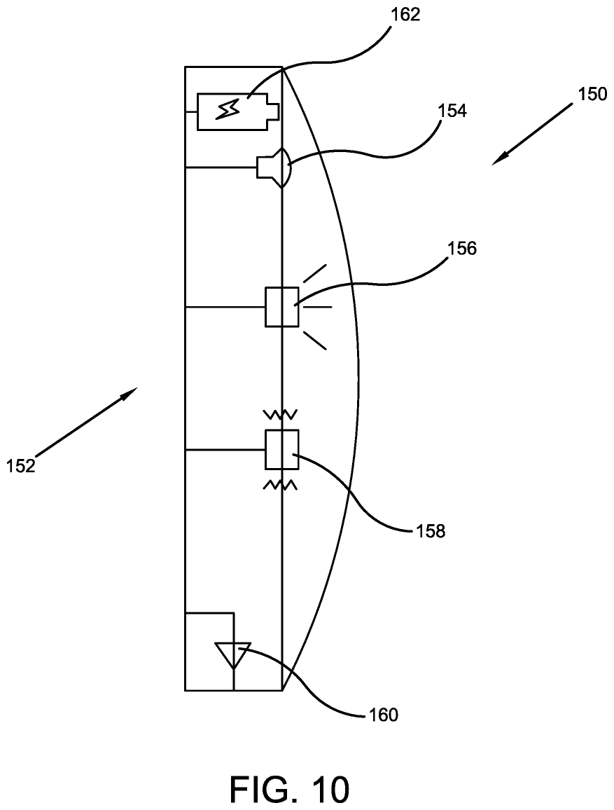

As illustrated in FIGS. 9 and 10, the alerting component 150 is removably insertable within the external pouch 140. The alerting component 150 comprises a location indicator 152. The location indicator 152 is configured to emit an audible alert, a visual alert, a vibratory alert, or a combination thereof. The location indicator 152 may comprise a speaker 154. The speaker 154 may broadcast an audible alert such as a series of beeps, noises, tones, music or words that the user may listen for to indicate the position of the object to be located alert when activated. The location indicator 152 may further comprise a light element 156. The light element 156 may be a low power lamp, such as a light emitting diode (LED) configured to emit a light signal to indicate the position of the object to be located alert when activated. The location indicator 152 may further comprise a vibrating element 158. The vibrating element 158 may vibrate to indicate the position of the object to be located alert when activated.

The alerting component 150 further comprises a communication receiving element 160 and a battery 162. The communication receiving element 160 is in wireless communication with the remote controller 170. The alerting component 150 may be enabled with Wi-Fi, Bluetooth, or any other similar form of wireless communication via a radio signal.

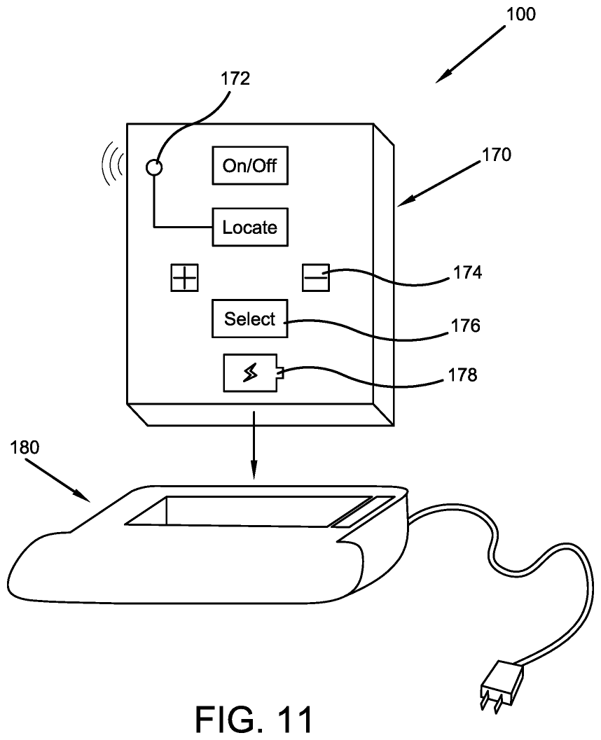

As illustrated in FIG. 11, the remote controller 170 is configured to activate the alerting component 150 wirelessly and remotely. The remote controller 170 comprises a transmitting element 172. The transmitting element 172 is in wireless communication with the communication receiving element 160 of the alerting component 150. The remote controller 170 further comprises a volume controller 174. The volume controller 174 is configured to control a volume of an audible signal emitted by the location indicator 152 of the alerting component 150.

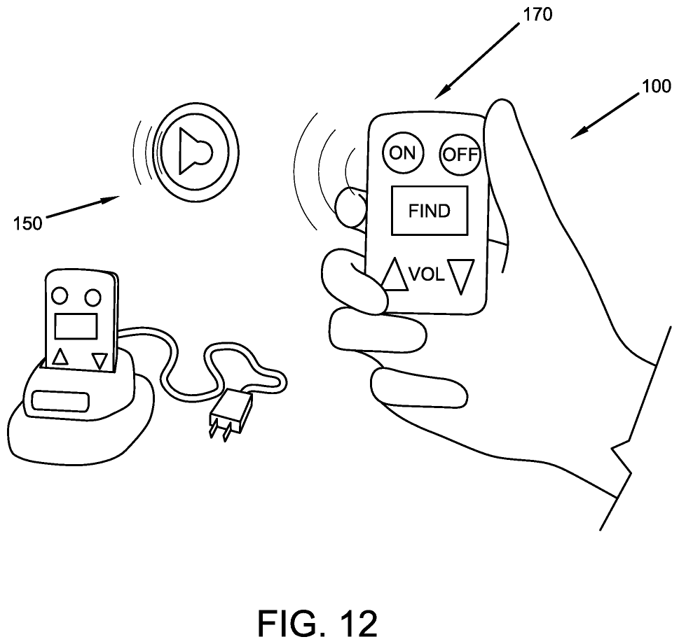

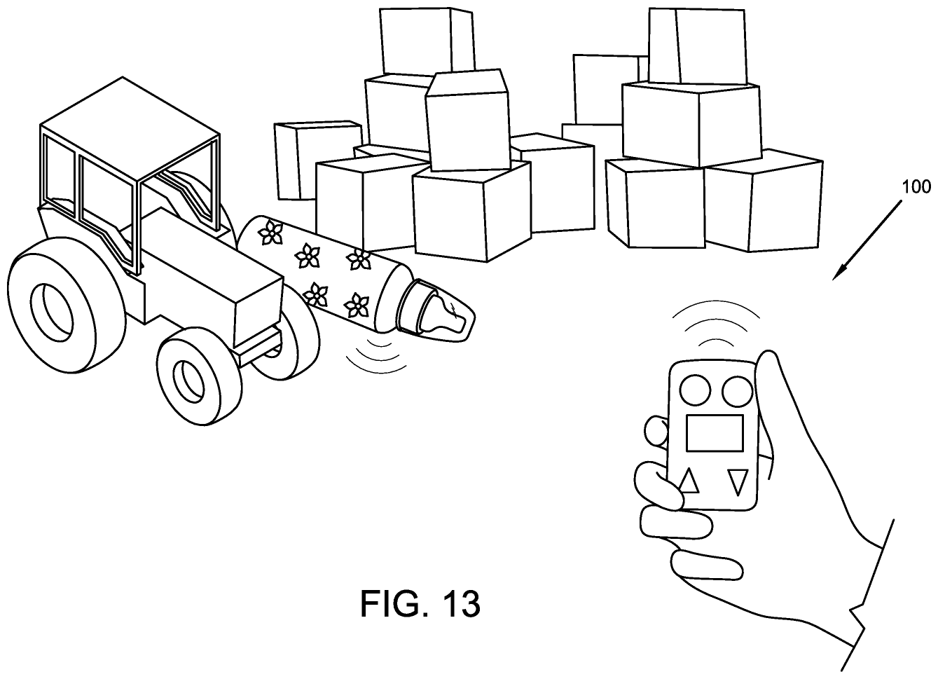

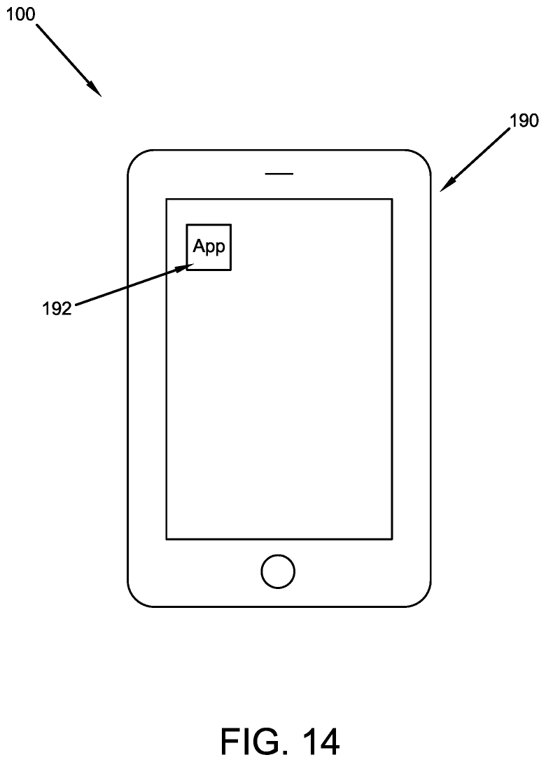

The remote controller 170 may further comprise a message selector 176 and a battery 178. The message selector 176 is configured to select a signal to be emitted by the location indicator 152 of the alerting component 150. The message selector 176 may select the type of audible alert, a pattern of the visual alert, a vibrational pattern, or the like. For example, the message selector 176 may be used to select a pattern of beeps, a message, or a sound to be broadcast as illustrated in FIGS. 12 and 13. Alternatively, the remote controller 170 may be a smart phone 190 and a mobile application 192 as illustrated in FIG. 14.

The locating system 100 further comprises a charging base 180. The charging base 180 is configured to charge the remote controller 170 and the alerting component 150. The charging base 180 is adapted to directly receive the remote controller 170 for charging when not in use. The charging base 180 may also be adapted to directly receive or wirelessly charge the alerting component 150 when it is removed from the external pouch 140 of the sleeve component 120 for charging.

To use the locating system 100, the sleeve component 120 is placed around the bottle 20 or sippy cup 20. The alerting component 150 is charges via the charging base 180 and is placed in the external pouch 140. To locate the bottle 20 or sippy cup 20, the remote controller 170 is used to wirelessly contact the location indicator 152. A signal is selected and transmitted to activate the alerting component 150. The user may then listen, look, or feel for the signal to find the bottle 20 or sippy cup 20.

It is contemplated that the locating system 100 is constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the forgoing, the locating system 100 of the present invention and its various structural components can be of any suitable size, shape, and configuration as is known in the art without affecting the overall concept of the invention, provided that it accomplishes the above stated objectives. One of ordinary skill in the art will appreciate that the shape and size of the locating system 100 and its various components and material, as shown in the FIGS. are for illustrative purposes only, and that many other shapes and sizes of the locating system 100 are well within the scope of the present disclosure. Although the dimensions of the locating device 100 are important design parameters, the locating system 100 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A locating system for indicating a position of a baby bottle, the locating system comprising:
a sleeve component comprising an external pouch, the sleeve component configured to partially encapsulate the baby bottle;
an alerting component comprising a location indicator, the alerting component removably insertable within the external pouch; and
a remote controller configured to wirelessly activate the alerting component.

2. The locating system of claim 1, wherein the sleeve component is elastic.

3. The locating system of claim 1, wherein the sleeve component further comprises at least one exterior indicia.

4. The locating system of claim 1, wherein the alerting component is configured to emit an audible alert.

5. The locating system of claim 1, wherein the alerting component is configured to emit a visual alert.

6. The locating system of claim 1, wherein the alerting component is configured to emit a vibratory alert.

7. The locating system of claim 1, wherein the alerting component is Wi-Fi enabled.

8. The locating system of claim 1, wherein the alerting component is Bluetooth enabled.

9. The locating system of claim 1, wherein the remote controller comprises a transmitting element and a volume controller.

10. A locating system for indicating a position of a child's drinkware, the locating system comprising:
a sleeve component comprising an external pouch, the sleeve component configured to partially encapsulate the child's drinkware;
an alerting component comprising a location indicator and a communication receiving element, the alerting component removably insertable within the external pouch; and
a remote controller comprising a transmitting element in wireless communication with the communication receiving element of the alerting component; and
wherein the remote controller is configured to remotely activate the alerting component.

11. The locating system of claim 10, wherein the child's drinkware is a sippy cup.

12. The locating system of claim 10, wherein the external pouch is at least partially transparent.

13. The locating system of claim 10, wherein the external pouch comprises a water-resistant interior.

14. The locating system of claim 10, wherein the external pouch comprises a plurality of sound openings.

15. The locating system of claim 10, wherein the sleeve component further comprises a bottom comprising a non-slip surface.

16. The locating system of claim 10, wherein the sleeve component further comprises a weighted bottom.

17. The locating system of claim 10, wherein sleeve component is a band.

18. The locating system of claim 10, wherein the remote controller further comprises a message selector for controlling the location indicator.

19. The locating system of claim 10, wherein the remote controller further comprises a volume controller for controlling the location indicator.

20. A locating system for indicating a position of a child's drinkware, the locating system comprising;
a sleeve component comprising an external pouch, the sleeve component configured to partially encapsulate the child's drinkware;
an alerting component comprising a location indicator configured to emit an audible and a visual signal, a communication receiving element, and a battery, the alerting component removably insertable within the external pouch;
a remote controller comprising a transmitting element in wireless communication with the communication receiving element of the alerting component; and
a charging base configured to charge the remote controller and the alerting component; and
wherein the remote controller is configured to remotely activate the location indicator of the alerting component.
